(19) United States
(12) Patent Application Publication
(10) Pub. No.: US 2015/0096519 A1
(43) Pub. Date: Apr. 9, 2015

(54) HUMIDITY BASED MAF COMPENSATION

(71) Applicants: Rogelio Rodriguez, Plainfield, IL (US); Chethana Bhasham, Naperville, IL (US); Ly V. Tran, Carol Stream, IL (US); Umang Khanna, Chicago, IL (US)

(72) Inventors: Rogelio Rodriguez, Plainfield, IL (US); Chethana Bhasham, Naperville, IL (US); Ly V. Tran, Carol Stream, IL (US); Umang Khanna, Chicago, IL (US)

(73) Assignee: International Engine Intellectual Property Company, LLC, Lisle, IL (US)

(21) Appl. No.: 14/047,421

(22) Filed: Oct. 7, 2013

(51) Int. Cl. F02D 41/00; F02D 41/14

(52) U.S. Cl. CPC F02D 41/0002; F02D 41/1487
USPC 123/184.21; 236/44 A

(57) ABSTRACT

According to at least one aspect of the present technology, a method is provided for compensating the output of a mass air flow sensor in response to humidity level. The method includes determining an actual mass air flow value (MAF_ACT) using the mass air flow sensor. The method also includes determining an actual humidity value (HUM_ACT) of the air flow that is measured by the mass air flow sensor. The method further includes determining if the actual humidity value (HUM_ACT) is outside of a preselected operating range. If the actual humidity value (HUM_ACT) is outside of the preselected operating range, the method determines a humidity-compensated mass air flow value (MAF_HUM) as a function of the actual mass air flow value (MAF_ACT) and the actual humidity value (HUM_ACT).

### BACKGROUND

Exhaust gas recirculation (EGR) is a technique that is commonly used to reduce nitrogen oxide (NOx) emissions in gasoline and diesel internal combustion engines. EGR works by recirculating a portion of an engine's exhaust gas back to the engine cylinders. In a gasoline engine, this inert exhaust gas displaces the amount of combustible matter in the cylinder. In a diesel engine, the exhaust gas replaces some of the excess oxygen in the pre-combustion mixture. Because NOx forms primarily when a mixture of nitrogen and oxygen is subjected to high temperature, the lower combustion chamber temperatures caused by EGR reduces the amount of NOx the combustion generates. As a result, modern engines commonly use exhaust gas recirculation to meet emission standards.

Modern engine systems typically include an electronic engine control unit (ECU) that controls operation of the engine based on measurements provided by a plurality of sensors. In this regard, engine control systems often include a mass air flow (MAF) sensor to measure the total intake of fresh air flow through an air induction system. As emission standards around the world continue to become a stricter limit, the need for more accurate sensors, such as MAF sensors, also increases. However, the accuracy of commercially available MAF sensors typically fluctuates based on environmental conditions, and particularly, in response to varying humidity levels. Accordingly, it is desirable to provide a means to compensate for the effect of humidity on the MAF sensor.

### SUMMARY

Aspects and embodiments of the present technology described herein relate to one or more systems and methods for compensating the output of a mass air flow sensor (MAF) based on humidity. According to at least one aspect of the present technology, a method is provided for compensating the output of a mass air flow sensor in response to humidity level. The method includes determining an actual mass air flow value (MAF_ACT) using the mass air flow sensor. The method also includes determining an actual humidity value (HUM_ACT) of the air flow that is measured by the mass air flow sensor. The method further includes determining if the actual humidity value (HUM_ACT) is outside of a preselected operating range. If the actual humidity value (HUM_ACT) is outside of the preselected operating range, the method determines a humidity-compensated mass air flow value (MAF_HUM) as a function of the actual mass air flow value (MAF_ACT) and the actual humidity value (HUM_ACT).

The actual humidity value (HUM_ACT) may be determined by reading an output of a humidity sensor. According to some embodiments, the humidity sensor outputs an analog signal that is converted to applicable physical units by a signal processing transfer function.

According to some aspects of the present technology, the actual humidity value (HUM_ACT) is compared to upper and lower humidity thresholds (HUM_MAX; HUM_MIN), to determine if the actual humidity value (HUM_ACT) is outside of the preselected operating range. In some embodiments, the upper humidity threshold (HUM_MAX) can be on the order of about !! to about !!, while the lower humidity threshold (HUM_MIN) can be on the order of about !! to about !!.

Aspects and embodiments of the present technology described herein also relate to one or more systems and methods for controlling an internal combustion engine. According to at least one aspect of the present technology, a method of controlling an internal combustion engine includes determining an actual mass air flow value (MAF_ACT) using a mass air flow sensor to measure the flow of fresh air into the engine. The method further determines an actual humidity value (HUM_ACT) using a humidity sensor to measure the humidity level of fresh air flowing into the engine. The method also determines if the actual humidity value (HUM_ACT) is within a predetermined operating range. The actual mass air flow value (MAF_ACT) is used to control engine operation when the actual humidity value (HUM_ACT) is within the predetermined operating range, while a humidity-compensated mass air flow value (MAF_HUM) is used to control engine operation when the actual humidity value (HUM_ACT) is outside the predetermined operating range. The humidity compensated mass air flow value (MAF_HUM) can be determined as a function of the actual mass air flow value (MAF_ACT) and the actual humidity value (HUM_ACT).

According to a further aspect of the present technology, a system for controlling an internal combustion engine includes a mass air flow sensor that measures the amount of fresh air entering the engine and produces a responsive output signal. A humidity sensor measures the humidity level of fresh air entering the engine and produces a responsive output signal. An engine control unit (ECU) determines an actual mass air flow value (MAF_ACT) based on the output of the mass air flow sensor. The ECU also determines an actual humidity value (HUM_ACT) based on the output of the humidity sensor. The ECU control engine operation using the actual mass air flow value (MAF_ACT) when the actual humidity value (HUM_ACT) is within a predetermined operating range, and controls engine operation using a humidity-compensated mass air flow value (MAF_HUM) when the actual humidity value (HUM_ACT) is outside the predetermined operating range. The humidity compensated mass air flow value (MAF_HUM) can be determined as a function of the actual mass air flow value (MAF_ACT) and the actual humidity value (HUM_ACT).

### BRIEF DESCRIPTION OF THE DRAWINGS

FIG. 1 is an exploded perspective view of an injector in accordance with at least one embodiment of the present technology.

FIG. 2 is flow chart of an exemplary method for compensating the MAF sensor signal as a function of actual humidity level.

FIG. 3 is exemplary logic for compensating the MAF sensor signal as a function of actual humidity level.

### DETAILED DESCRIPTION

Embodiments will be described more fully hereinafter with reference to the accompanying drawings, in which embodiments are shown. Like reference numbers refer to like elements throughout. Other embodiments may, however, be in many different forms and are not limited to the embodiments set forth herein. Rather, these embodiments are examples. Rights based on this disclosure have the full scope indicated by the claims.

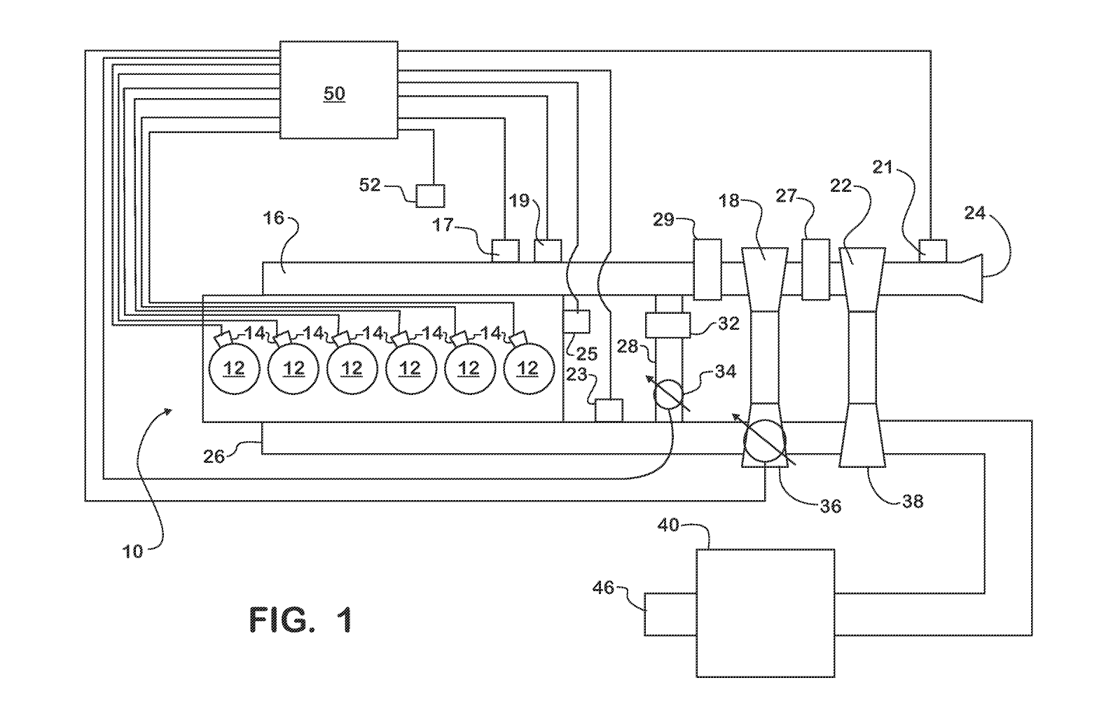

FIG. 1 shows a schematic depiction of a compression ignition engine. Air enters the engine 10 at air inlet 24. A mass air flow sensor 21 senses the amount of air entering the engine through air inlet 24. Air is directed from air inlet 24 to a low pressure turbocharger compressor 22 which compresses the air. Compressed air is directed from the low pressure turbocharger compressor 22 to a high pressure turbocharger compressor 18 which further compresses the air. Compressed air is then directed to an intake manifold 16. As further described below, an exhaust gas recirculation system 28 selectively directs exhaust gas into the compressed air entering the intake manifold 16.

Air and, under some operating conditions, exhaust enters the cylinders 12 of the engine 10 through the intake manifold 16. An intake flow temperature sensor 19 and an intake flow pressure sensor 17 are mounted to the intake manifold 16 to measure the temperature and pressure of the flow entering the cylinders 12 of the engine 10. An injector 14 is provided for each cylinder 12 to inject fuel into the cylinder 12.

After combustion of fuel in the cylinders 12, exhaust from the cylinders 12 is directed to an exhaust manifold 26. The exhaust manifold 26 directs exhaust to a connection to the exhaust recirculation system 28 and to a high pressure turbocharger turbine 36. An exhaust oxygen sensor 23 measures the amount of oxygen in the exhaust leaving the engine 10. Oxygen sensor 23 may be a lambda sensor.

The exhaust gas recirculation system 28 provides a passage for exhaust leaving the exhaust manifold 26 to enter the flow of compressed air from the turbocharger compressor 18 entering the intake manifold 16. The exhaust entering the exhaust gas recirculation system 28 is directed to a controllable EGR valve 34 and then to an exhaust cooler 32 that lowers the temperature of exhaust. Exhaust is then directed into the flow of compressed air from the turbocharger compressor 18. The pressure of exhaust in the exhaust manifold 26 is higher than pressure in the intake manifold 16 thereby causing exhaust to flow from the exhaust manifold 26, through the exhaust gas recirculation system 28, and into the intake manifold 16.

Exhaust that does not flow through the exhaust gas recirculation system 28 flows to and through the high pressure turbocharger turbine 36. The high pressure turbocharger turbine 36 is driven by exhaust from the exhaust manifold 26 and drives the high pressure turbocharger compressor 18. The high pressure turbocharger turbine 36 includes a controllable variable nozzle. Opening that controllable variable nozzle decreases driving of the high pressure turbocharger turbine 36 and consequently decreases compression of air by the high pressure turbocharger compressor 18. Opening the variable nozzle of the high pressure turbocharger turbine 36 also decreases resistance of the high pressure turbocharger turbine 36 to the flow of exhaust, thereby lowering pressure of exhaust within the exhaust manifold 26 and exhaust gas recirculation system 28. Conversely, closing the variable nozzle of the high pressure turbocharger turbine 36 increases pressure of exhaust within the exhaust manifold 26, increases driving of the high pressure turbocharger turbine 36, and increases compression of air by the high pressure turbocharger compressor 18.

Exhaust is directed from the high pressure turbocharger turbine 36 to a low pressure turbocharger turbine 38 that drives the low pressure compressor 22. Exhaust is directed from the low pressure turbocharger turbine 38 to an inlet 42 of an exhaust aftertreatment system 40.

The aftertreatment system 40 is configured to reduce the amount of undesirable components of exhaust. Exhaust that has been subjected to treatment by the aftertreatment system 40 exits the aftertreatment system 40 at exit 44 from which it is directed to an exhaust discharge outlet 46.

An engine control unit (ECU) 50 controls operation of the engine 10 based on measurements provided by a plurality of sensors. In the illustrated embodiment, the intake pressure sensor 17, intake temperature sensor 19, mass air flow sensor 21, exhaust oxygen sensor 23, an engine speed sensor 25 and a humidity sensor 52 are connected to communicate measurements to the ECU 50 as indicated in FIG. 1. The ECU 50 controls each of the injectors 14 to control the timing and amount of fuel that is injected into the cylinder 12. The ECU 50 also controls the controllable EGR valve 34 to open and close the valve 34 thereby increasing and decreasing the flow of exhaust gas into the intake manifold 16. The ECU 50 also controls the variable nozzle of the high pressure turbocharger turbine to increase and decrease compression of air by the high pressure turbocharger compressor 18.

As noted above, actual humidity can have a significant effect on the accuracy of a MAF sensor. In particular, the amount of water vapor can affect heat transferred to the sensor's sensing element. As a result, when relative humidity increases, the percent correction applied to applied to the mass flow rate increases in the negative direction and vice-versa. Accordingly, certain aspects of an embodiment of the present technology compensate the output of the MAF sensor as a function of the actual humidity level.

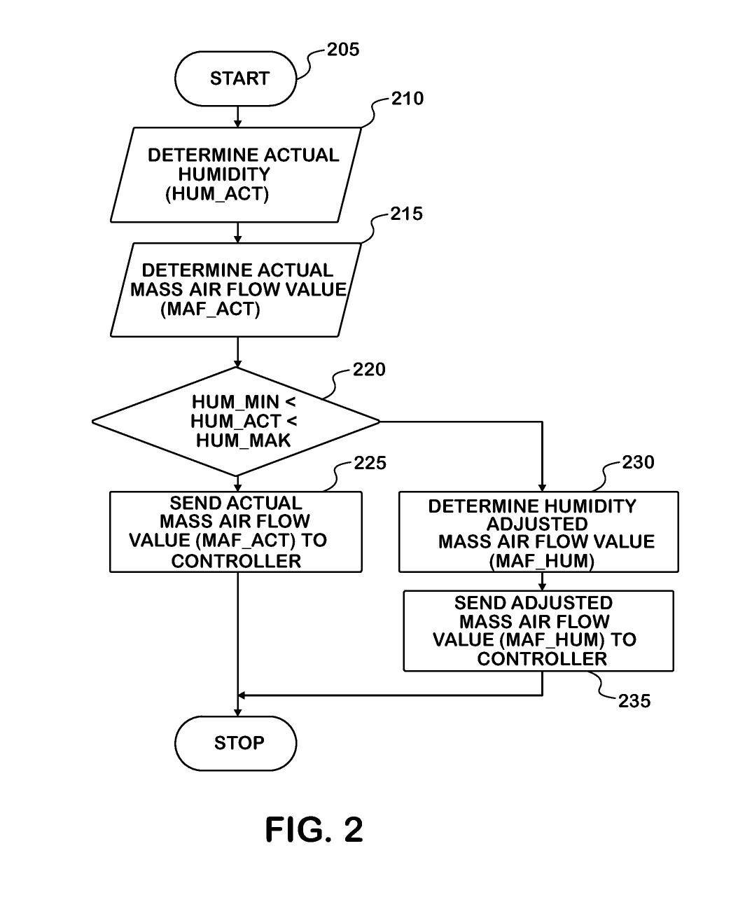

In this regard, FIG. 2 is a flow chart of an exemplary method for compensating the MAF sensor signal function of the actual humidity level. A method 200 begins in step 205. Control is then passed to step 210, where the exemplar method of the present technology determines the actual humidity level (HUM_ACT). According to some embodiments, the actual humidity level (HUM_ACT) is determined by reading the output from the humidity sensor 52. According to some embodiments, the humidity sensor 52 outputs an analog signal that is converted to applicable physical units (for example grams of water vapor per kilogram of air) using an appropriate signal processing transfer function. According to some embodiments, humidity sensors can be based of capcitive or resistive sensor signal conditioning. The outcome of this conditioning, which is voltage vs. relative humidity, may be provided by the sensor manufacturer. Based on the application requirement, this raw analog voltage signal is sensed by the Engine Control Module (ECM) at Basic Input/output (BIOS) layer. A voltage-to-relative humidity transfer function may then be interpreted in software as curve interpolation. In some embodiments, a 1-D linear interpolation of input values may be performed using this voltage versus relative humidity specified table. Once the actual humidity level is determined, control is passed to step 215. In step 215, the method determines the actual mass air flow valve (MAF_ACT) e.g., based on the output of the MAF humidity sensor 52.

Control is then passed to step 220, where the exemplar method 200 determines if the actual humidity (HUM_ACT) is within a predetermined operating range. According to some embodiments of the present technology, the predetermined operating range corresponds to a range of humidity levels that do not significantly affect the accuracy of the MAF sensor. The predetermined operating range may be defined by upper and lower thresholds (HUM_MAX) and (HUM_MIN). As will be appreciated, the predetermined operating range will typically depend upon factors including the specific MAF sensor that is used and the accuracy level that is desired from the sensor. According to some embodiments, the upper humidity threshold (HUM_MAX) or the lower humidity threshold (HUM_MIN) depends on the accuracy of mass air flow required to maintain the accuracy or control system to meet the set regulatory requirements. This includes testing at different humidity levels in combination with different ambient temperatures. The error induced by variation in humidity is benchmarked so the appropriate thresholds can be determined. In some embodiments, the metric for benchmark is defined based on the emission and performance trade-off.

If the actual humidity level (HUM_ACT) is within the predetermined operating range, i.e., if it falls between the upper and lower thresholds (HUM_MAX and HUM_MIN), control is passed to step 225, which causes the ECU to use the actual mass air flow value (MAF_ACT) (as determined in step 210) to control engine operation.

Alternatively, if the actual humidity level (HUM_ACT) falls outside the predetermined operating range, i.e., if it exceeds the upper threshold (HUM_MAX) or falls below the lower threshold (HUM_MIN), control is passed to step 230. In step 230, an adjusted mass air flow value (MAF_HUM) is determined based on the actual humidity (HUM_ACT) and the actual mass air flow signal (MAF_ACT). According to some embodiments, the method uses a look-up table to determine a humidity compensation factor (HUM_COMP) based on the actual humidity (HUM_ACT). As the relative humidity increases from 0%-100%, the correction factor can vary from 0%-5% in the negative direction and vice-versa. This correction factor, when compensated with read mass air flow, shifts the curve below the nominal line when increase is in negative direction and vice-versa. The humidity compensation factor (HUM_COMP) is then applied to the actual mass air flow value (MAF_ACT) to produce the adjusted mass air flow value (MAF_HUM). Control is then passed to step 235, causing the causes the ECU to use the adjusted mass air flow value (MAF_HUM) (as determined in step 230) to control engine operation.

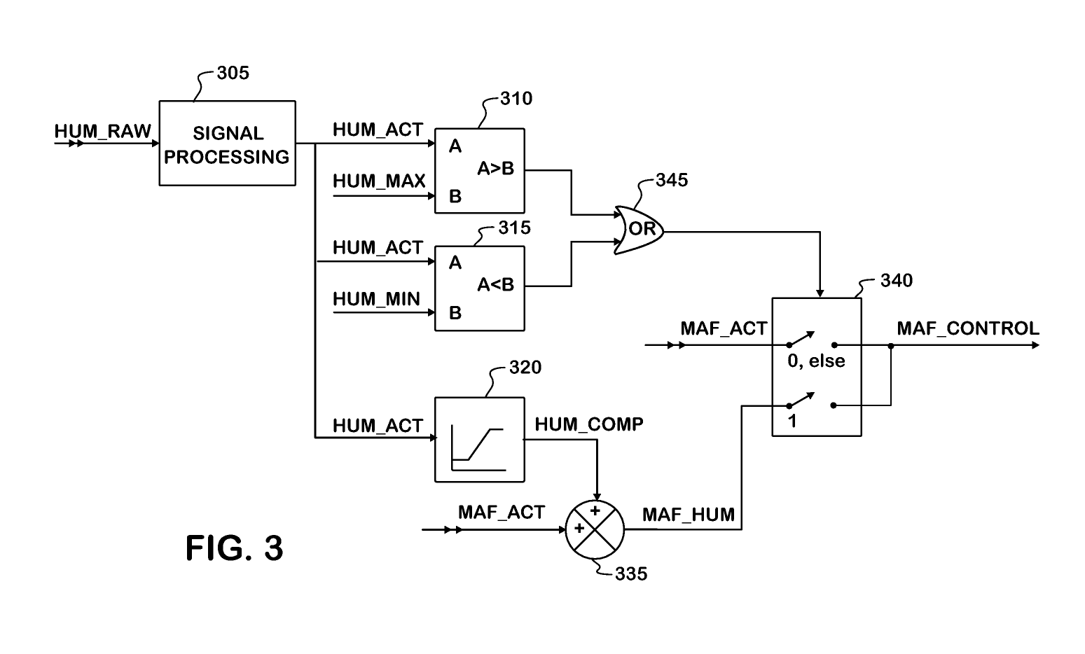

FIG. 3 is exemplary control logic 300 for compensating the output of a MAF sensor based on actual humidity. The control logic 300 includes a signal processing block 305 that processes the signal (HUM_RAW) from the humidity sensor 52 to produce an actual humidity value (HUM_ACT). In some embodiments, the humidity sensor 52 outputs an analog signal that the process block 305 converts to applicable physical units (for example, grams of water vapor per kilogram of air) using an appropriate signal processing transfer function.

The actual humidity value (HUM_ACT) from the signal processing block 305 is applied to one input of a first comparator 310. A signal corresponding to the upper humidity threshold (HUM_MAX) is applied to the other input of the first comparator 310. The first comparator 310 produces a logic 1 output when the actual humidity value (HUM_ACT) exceeds the upper humidity threshold (HUM_MAX) and produces a logic 0 output when the actual humidity value (HUM_ACT) is at or below the upper humidity threshold (HUM_MAX).

The actual humidity value (HUM_ACT) from the signal processing block 305 is also applied to an input of a second comparator 315. A signal corresponding to the lower humidity threshold (HUM_MIN) is applied to the other input of the second comparator block 315. The second first comparator 315 produces a logic 1 output when the actual humidity value (HUM_ACT) falls below the lower humidity threshold (HUM_MIN) and produces a logic 0 output when the actual humidity value (HUM_ACT) is at or above the lower humidity threshold (HUM_MIN).

The actual humidity value (HUM_ACT) from the signal processing block 305 is also applied to the input of a look-up table 320. The look-up table 320 outputs a humidity compensation factor (HUM_COMP) based on the actual humidity (HUM_ACT). The humidity compensation factor (HUM_COMP) is then summed with the actual mass air flow value (MAF_ACT) by summer 335 to produce the adjusted mass air flow value (MAF_HUM). The compensation factor can be a percent correction factor correlating to the relative humidity provided by the sensor. The percent correction factor can vary depending on how much mass air flow without water vapor is required to maintain system accuracy or to maintain precise control system.

The actual mass air flow value (MAF_ACT) and the adjusted mass air flow value (MAF_HUM) are applied to the inputs of a switch block 340. The switch block 340 is controlled in response to the actual humidity value (HUM_ACT) to select which mass air flow value, i.e., the actual (MAF_ACT) or adjusted (MAF_HUM), is used by the ECU to control engine operation. To this end, the outputs from the first and second comparators 310, 315 are applied to the inputs of an OR logic gate 345. OR logic gate 345 outputs a logic 1 if either of its inputs are a logic 1. In other words, OR logic gate 345 outputs a logic 1 whenever the actual humidity value (HUM_ACT) exceeds the upper humidity threshold (HUM_MAX) or falls below the lower humidity threshold (HUM_MIN). The output of OR logic gate 345 is applied to switch block 340 to switch between the actual mass air flow value (MAF_ACT) and the adjusted mass air flow value (MAF_HUM). In particular, if the OR gate 345 outputs a logic 1 (indicating that the actual humidity value (HUM_ACT) is outside of the operating range defined by the upper and lower humidity thresholds), switch block 340 outputs the humidity adjusted mass air flow value (MAF_HUM). Conversely, if the OR gate outputs a logic 0 (indicating that the actual humidity value (HUM_ACT) is a value within the operating range defined by the upper and lower humidity thresholds), switch block 340 outputs the actual mass air flow value (MAF_ACT). The value output from the switch circuit 340 (MAF_CONTROL) is used by the ECU 50 in controlling engine operation.

While this disclosure has been described as having exemplary embodiments, this application is intended to cover any variations, uses, or adaptations using the general principles set forth herein. It is envisioned that those skilled in the art may devise various modifications and equivalents without departing from the spirit and scope of the disclosure as recited in the following claims. Further, this application is intended to cover such departures from the present disclosure as come within the known or customary practice within the art to which it pertains. While this disclosure has been described as having exemplary embodiments, this application is intended to cover any variations, uses, or adaptations using the general principles set forth herein. It is envisioned that those skilled in the art may devise various modifications and equivalents without departing from the spirit and scope of the disclosure as recited in the following claims. Further, this application is intended to cover such departures from the present disclosure as come within the known or customary practice within the art to which it pertains.

1. A method for compensating the output of a mass air flow sensor in response to humidity level, the method comprising:
determining an actual mass air flow value (MAF_ACT) using the mass air flow sensor;
determining an actual humidity value (HUM_ACT) of the air flow that is measured by the mass air flow sensor;
determining if the actual humidity value (HUM_ACT) is outside of a preselected operating range;
if the actual humidity value (HUM_ACT) is outside of the preselected operating range, then determining a humidity compensated mass air flow value (MAF_HUM) as a function of the actual mass air flow value (MAF_ACT) and the actual humidity value (HUM_ACT).

2. The method of claim 1, wherein the step of determining an actual humidity value (HUM_ACT) comprises reading an output of a humidity sensor.

3. The method of claim 1, wherein the step of determining an actual mass air flow value (MAF_ACT) comprises reading an output of the mass air flow sensor.

4. The method of claim 1, wherein the step of determining if the actual humidity value (HUM_ACT) is outside of a preselected operating range comprises determining if the actual humidity value (HUM_ACT) exceeds an upper humidity threshold (HUM_MAX).

5. The method of claim 4, wherein the upper humidity threshold (HUM_MAX) is on the order of about !! to about !!.

6. The method of claim 1, wherein the step of determining if the actual humidity value (HUM_ACT) is outside of a preselected operating range comprises determining if the actual humidity value (HUM_ACT) is below a lower humidity threshold (HUM_MIN).

7. The method of claim 6, wherein the lower humidity threshold (HUM_MIN) is on the order of about !! to about !!.

8. A method of controlling an internal combustion engine comprising:
determining an actual mass air flow value (MAF_ACT) using a mass air flow sensor to measure the flow of fresh air into the engine;
determining an actual humidity value (HUM_ACT) using a humidity sensor to measure the humidity level of fresh air flowing into the engine;
determining if the actual humidity value (HUM_ACT) is within a predetermined operating range;
controlling engine operation using the actual mass air flow value (MAF_ACT) when the actual humidity value (HUM_ACT) is within the predetermined operating range, then;
controlling engine operation using a humidity compensated mass air flow value (MAF_HUM) when the actual humidity value (HUM_ACT) is outside the predetermined operating range, where the humidity compensated mass air flow value (MAF_HUM) is determined as a function of the actual mass air flow value (MAF_ACT) and the actual humidity value (HUM_ACT).

9. The method of claim 8, wherein the step of determining if the actual humidity value (HUM_ACT) is within the preselected operating range comprises determining if the actual humidity value (HUM_ACT) exceeds an upper humidity threshold (HUM_MAX).

10. The method of claim 9, wherein the upper humidity threshold (HUM_MAX) is on the order of about !! to about !!.

11. The method of claim 8, wherein the step of determining if the actual humidity value (HUM_ACT) is within the preselected operating range comprises determining if the actual humidity value (HUM_ACT) is below a lower humidity threshold (HUM_MIN).

12. The method of claim 11, wherein the lower humidity threshold (HUM_MIN) is on the order of about !! to about !!.

13. A system for controlling an internal combustion engine, comprising:
a mass air flow sensor for measuring the amount of fresh air entering the engine and producing an output signal in response thereto;
a humidity sensor for measuring the humidity level of fresh air entering the engine and producing an output signal in response thereto;
an engine control unit configured to
determine an actual mass air flow value (MAF_ACT) based on the output of the mass air flow sensor;
determine an actual humidity value (HUM_ACT) based on the output of the humidity sensor;
control engine operation using the actual mass air flow value (MAF_ACT) when the actual humidity value (HUM_ACT) is within a predetermined operating range;
control engine operation using a humidity compensated mass air flow value (MAF_HUM) when the actual humidity value (HUM_ACT) is outside the predetermined operating range, where the humidity compensated mass air flow value (MAF_HUM) is determined as a function of the actual mass air flow value (MAF_ACT) and the actual humidity value (HUM_ACT).
